(19) United States
(12) Patent Application Publication
(10) Pub. No.: US 2024/0303938 A1
(43) Pub. Date: Sep. 12, 2024

(54) AUGMENTED REALITY SECONDARY CONTENT SYSTEM AND METHOD

(71) Applicant: Eventshop, Inc., brentwood, TN (US)

(72) Inventors: Spencer S Combs, Brentwood, TN (US); Trey Cushman, Brentwood, TN (US); Jeremy Cowart, brentwood, TN (US)

(21) Appl. No.: 18/437,515

(22) Filed: Feb. 9, 2024

Related U.S. Application Data
(60) Provisional application No. 63/444,363, filed on Feb. 9, 2023.

(51) Int. Cl. G06T 19/00; G06V 20/20

(52) U.S. Cl. CPC G06T 19/006; G06V 20/20

(57) ABSTRACT

An augmented reality content distribution method and system provides for distributing secondary content. The method and system, via an image capture application executing on a mobile computing device, detects a first image disposed on a physical item, the physical item relating to a primary event and/or primary content. Therein, the method and system accesses a secondary content database across a network communication path and retrieves the secondary content based on the first image as detected by the image capture application. The method and system therein displays, on an output display of the mobile computing device, the secondary content in an augmented reality display in relation to the first image and the physical item, wherein the secondary content is associated with the primary event and/or primary content.

### RELATED APPLICATIONS

The present application relates to and claims priority to U.S. Provisional Patent Application Ser. No. 63/444,363 filed Feb. 9, 2023.

### FIELD OF THE INVENTION

The invention relates to generally to distributing augmented reality content and more specifically to providing augmented reality secondary content to recipients based on existing interactions.

### BACKGROUND

It is common for individuals to attend events and purchase commemorative items (e.g. t-shirt, poster, artwork, etc.). Users leaving these events are left with vivid memories and experiences, but promoters, managers, and other professionals are leaving behind huge opportunities to generate additional contact points and sharing content.

Individuals are already purchasing these items, there exists a need for tying in additional content distribution through these items. Existing solutions are extremely low-tech, for example collecting email and/or social media addresses at an event and distributing follow-up messages via electronic communication platforms.

There is a growing opportunity and emergence in electronic solutions for content distribution, including increasing utilization of augmented reality or other types of overlay presentations. For example, a common technique is using a quick response (QR) code comprised of various elements in a block design. The QR code is readable by a mobile phone and then triggers accessing a dedicated web page.

While QR codes offer a low-cost solution for web access and allowing the user to subsequently download content, this is not an ideal solution for commemorative items. For example, a commemorative t-shirt from a concert includes the band's image and placing a large QR code in the shirt is not a palatable solution.

There is a need for technical solutions using existing augmented reality (AR) technology to supplement or compliment user experiences. Existing AR technology relates to recognizing objects and delivering content via a mobile phone or other portable device. Missing is tying the content to compliment an experience or event.

### BRIEF DESCRIPTION

The invention provides for accessing extra content from a special in-person event. For example, a concert goer attends a concert and purchases an item, for example a t-shirt or a poster. The user can view the item using an AR application, a logo on the item acting as an identification code for accessing supplementary content, such as a

AR content. The mobile app then acquires the supplementary content via a secure server and displays the secondary content from the event in an augmented reality display. In one embodiment, the display can be over the logo or relation to the item. Thus, the item now acts as a trigger and an AR platform for viewing secondary content, which can be associated with the event.

The method and system provides for merging physical items with AR content. The physical items relate to or are associated with an event, artist, team, or other item. The AR content compliments the event, artist, team, etc.

The method and system includes front-end user interfacing, including an AR viewer on a mobile computing device. The method and system includes back-end data processing, including content upload and management, as well as systematic distribution to viewers.

On the user side, the user can download the mobile application and run the application on the mobile device. The application may include a login or other account details. The application operates with the camera in the mobile device including image capture.

The mobile device captures the image of the item and performs processing operations to recognize the item. Upon recognition, the application then provides for the display of AR content. In a typical embodiment, the mobile application communicates with a back-end or network server for both recognizing the user/the item and receiving selected secondary content, which is AR content, based thereon.

Via the application, the mobile device can then display the AR content in an overlay over or in relation to the item. In the example of a t-shirt, the band logo transforms to an AR display of the band performing a song. In the example of a poster, the poster image transforms into an AR display of additional content, such as videos from the event, videos or messages generated by the band, and related content.

On the network-side, one embodiment includes uploading and managing content. This content management includes receiving event content from photographers. Content management can include approving content for distribution, as well as validating ownership and associated rights, royalties, etc.

The network processing environment includes processing content for subsequent distribution to the mobile user. This processing can include image processing steps, such as converting a video file into a 3D AR display, such as editing content for ease of transmission and improving viewability, etc.

Based on receipt of the mobile device access request, which can include user account and/or authorization information, the network processing device(s) transmit the AR content to the mobile device. The mobile device application then displays the content in the overlay AR environment.

The present method and system includes further technical embodiments on the network-side relating to content management and distribution.

In one embodiment, the network-based system can manage and distribute different AR content to based on different conditions. This can include using the same item as the foundation and changing the content, for example content can be timely based current or promotional events, the content can be related to a concert or event, the content can be specific and timely to the user such as a personalized message to the user on his or her birthday. Herein, the back-end system can store, manage, and transmit AR content and change the content itself based on any number of factors.

One embodiment may include a subscription service associated with or purchased by the user. In this example, the subscription service can include timely updates to distributed AR content, such as new content being released on a daily, weekly, monthly, or other periodic intervals. The new content can be tied to a distribution source, such as affiliated with an artist, band, professional team, etc.

In one embodiment, the user can sign up and pay for the subscription. In one embodiment, the subscription may be a condition of the item purchase, for example a concert poster having a purchase price that includes a 1, 3, 6, or 12 month subscription to AR content.

In one embodiment, the back-end system may include a marketplace for purchasing or directing users to commercial transactions. For example, AR content may include content to be purchased or otherwise owned by the individual. The back-end system can process ownership details for purchase and/or ownership of the AR content. In one embodiment, the back-end system may redirect the user to one or more commercial interfaces for purchasing physical items, for example purchasing a t-shirt having an image from an AR video displayed on a souvenir poster purchased at a recent concert.

Herein, the method and system uses AR technology to improve and compliment user experiences by using physical items associated with the experience as a foundation and executable operations to access and display additional visual content.

### BRIEF DESCRIPTION OF THE DRAWING

The invention will be described with respect to the following drawing figures, in which like numerals represent like features throughout the description, and in which:

FIG. 1 is a schematic diagram of a processing system;

FIG. 2 is a schematic diagram of one embodiment of a mobile computing device;

FIG. 3 is a schematic diagram of one embodiment of a network processing system;

FIG. 4 is a flowchart of the steps of one embodiment of a method for augmented reality distribution;

FIG. 5 is a flowchart of multiple interactive embodiments for user engagement, content distribution and content management within the augmented reality distribution system;

FIG. 6 is a sample illustration of item recognition;

FIG. 7 is a sample illustration of AR content overlay;

FIG. 8 is a sample illustration of item recognition; and

FIG. 9 is a sample illustration of AR content overlay.

### DETAILED DESCRIPTION

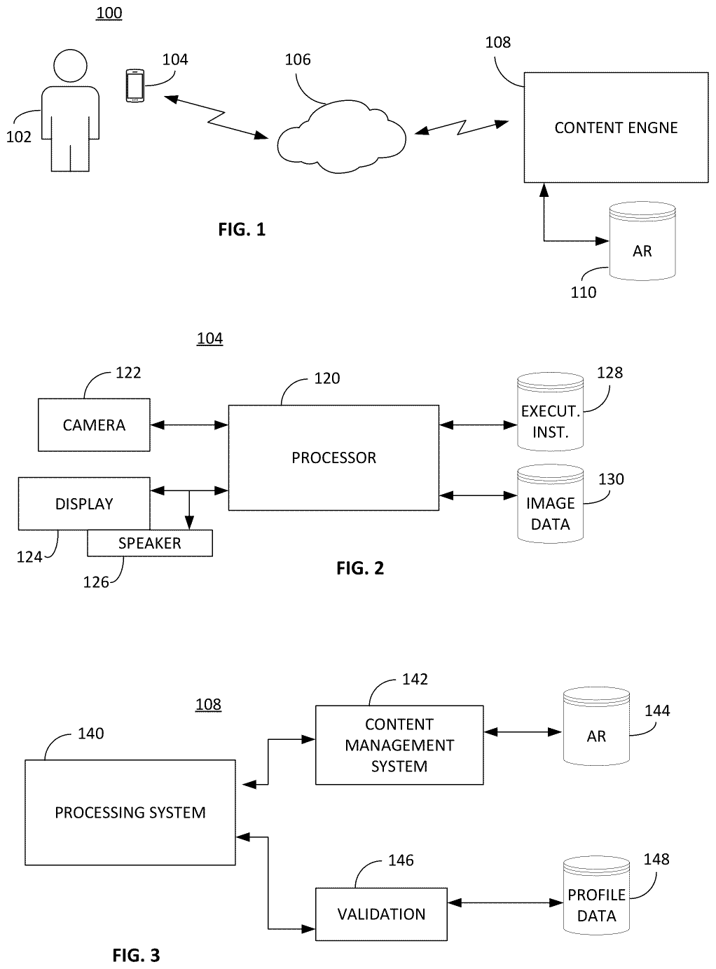

FIG. 1 is a schematic diagram of a system providing for augmented reality secondary content. The system 100 includes a user 102 with a mobile computing device 104 having network access. The network 106 provides communication with a network-based content engine 108, having AR content, as secondary content, associated therewith.

The user 102 is any individual or group of users. In one embodiment, the user attends or associated with a primary event, the primary event being, for instance, a particular event and/or being a fan of a team, performer, band, etc. The secondary content compliments the interest of the user and relates to the primary event. For instance, if the user is a fan of a particular musical group, the secondary content can be performance footage of the group.

The mobile computing device 104 can be any suitable type of mobile computing device, including but not limited to a smartphone, tablet computer, AR glasses or other type AR system or headset, laptop or desktop computer, gaming system, etc. In a typical embodiment, the mobile computing device 104 is a smart phone or tablet computer having processing elements for executing applications therein.

The network 106 can be one more wired and/or wireless networks, otherwise generally referred to as the Internet. For example, a mobile phone may connect via a wireless hotspot using a wi-fi connection through a router connected to a wired network connection. For example, a mobile phone may connect via a cellular network as a gateway.

The network-based content engine 108 can be disposed within a central or distributed network processing environment. For example, the engine 108 can be within a dedicated network server or can be distributed across a web service provider. On the network-side, the content database can be one or more data storage elements having secondary content stored therein, also referred herein as a secondary content database. As described in greater detail below, this data can be specifically generated for AR distribution or can be content managed and/or transformed for AR distribution.

FIG. 2 illustrates one embodiment of the processing within the mobile computing device 104. The mobile device 104 includes a local processor 120, camera 122, display 124, speaker 126, executable instruction storage 128, and image storage 130.

The executable instructions within the storage 128 can include application instructions, otherwise referred to as an app. In one embodiment, the user can download the app to the mobile device and launch or execute the application via the display 124. The storage is a non-transitory computer readable storage medium for storing executable instructions of the application therein.

The display 124 can be both an input and output device, for example a touchscreen. The speaker 126 can local or Bluetooth. Further embodiments are within the scope of the invention as recognized by a skilled artisan, for example display 124 and speaker 126 can be on a secondary display such using a mirroring function or other wired or wireless distribution for output content.

The application executes on the processor 120 for performing operations as noted herein. For example, in one embodiment, the application can be downloaded from a network-based repository such as an application store. The application can include accessing and using various input and output elements of the mobile processing device 104, for example using the camera 122 for image capture, the processor 120 for processing operations, and display 124, speaker 126 for output operations.

The image data, also referred to as secondary content, stored in the database 130 can be transmitted across the network 106 and processed for output via the display 124 and speaker 126. In one embodiment, the image data includes AR content visible in an AR overlay viewer. In other embodiments, the image data can be flat or 2D imagery such as a static picture or a video, such as simply being visible on the display 124 but not integrated into a formal AR viewer format.

The image data can also be transitory, locally stored as part of the viewing process but not permanently locally stored. In another embodiment, the content can be locally stored and access to viewing the content can be monitored or triggered by external factors, therefore enabling AR content display without requiring the mobile device to be actively connected to an external network.

FIG. 3 illustrates one embodiment of the network side, including content engine 108. The engine includes a processing system 140 may be one or more processing devices for receiving content requests from the applications running on the mobile devices.

This embodiment includes a content management system 142 for receiving, managing, and distributing authorized secondary content. This system 142 communicates with at least one AR content database 144. The AR content database includes the content transmitted to the mobile device 102 of FIG. 2. For instance, a musical artist may generate a video thanking fans for attending a recent concert and upload the video as secondary content to the database 144.

This embodiment further includes a validation module 146 in communication with a profile data database 148 having user profile data stored therein. The validation module 146 provides for authenticating the user and validating the user is authorized for receiving or viewing the image data from the database 144.

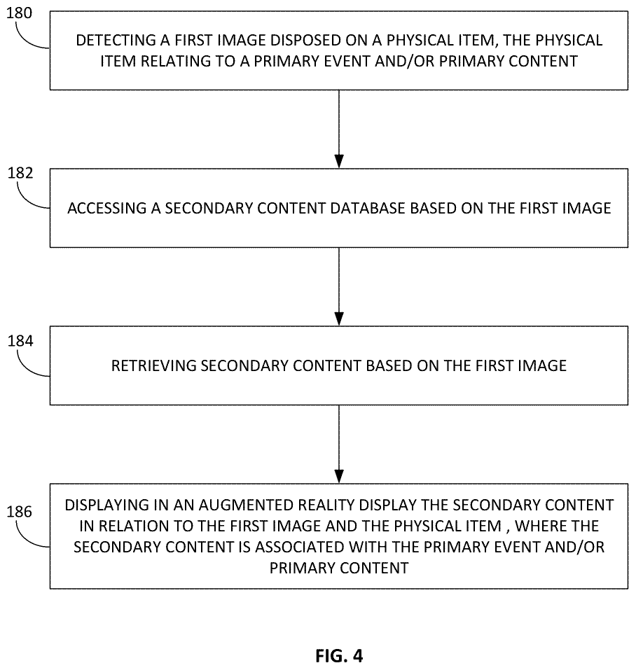

The elements of FIGS. 1-3 are illustrative in nature and not an exhaustive or exclusive list of software and processing elements. The present invention includes variations in these elements as recognized by a skilled artisan

Where FIGS. 1-3 illustrate various embodiments and elements of an augmented reality content distribution system, FIG. 4 is a flowchart of the steps of one embodiment. These operations steps may be performed by the user's processing device capable of providing augmented reality display, for example a mobile phone, laptop computer, video game console system, AR headsets, AR glasses, etc.

Step 180 is detecting a first image disposed on a physical item, the physical item relating to a primary event and/or primary content. In one example, the physical item can be a t-shirt from a concert, the t-shirt having the band's name/logo and information about the current tour. In this example, the t-shirt relates to the primary event being the concert and/or the primary content being the user's experience while at the concert. The detecting of the first image can be performed by the application using the camera viewing the t-shirt and the logo. Whereas prior art solutions used QR codes to generate a response by a browser application, in the present method and system the application can use the physical item for detection, while imagery or other elements of the physical item as the triggering event for recognition of the item and subsequent AR overlay initiation.

When executed by the application, the detection operation can trigger a network data call. Step 182 is accessing a secondary content database based on the first image. Using the above example, the image of the band's logo and concert image is detected and leads to a specific data call.

Step 184 is retrieving secondary content based on the first image. This retrieval can including a network-based data call from the application via a content server and one or more content databases. The data call can include retrieval or other identifier information, including if needed authentication information to validate the recipient is entitled to receive the content. This secondary content is formatted or otherwise available for presentation in an augmented reality output display.

Retrieval operations of step 184 can include additional back-end processing operations as noted herein. For example, digital rights management operations can include authentication or verification of authorization for content distribution, as well as an renumeration or other licensing pay-outs as part of the system and method.

Step 186 is displaying, on an output display of the mobile computing device, the secondary content in an augmented reality display in relation to the first image and the physical item. Herein, the secondary content is related to the primary event and/or primary content. For example, as described in greater detail below, a primary event may be a concert and the secondary content can be a video from the band thanking them for attending the event, an audio/visual highlight reel of the event, etc. Moreover the display of the AR content in relation to the item can be any suitable type of display, including in one embodiment having the secondary content visible as an overlay over the item itself or in amount embodiment having the secondary content generally visible in an AR environment, for example coming out of a floor, desk or operating in a general space and not specifically tied to the item itself.

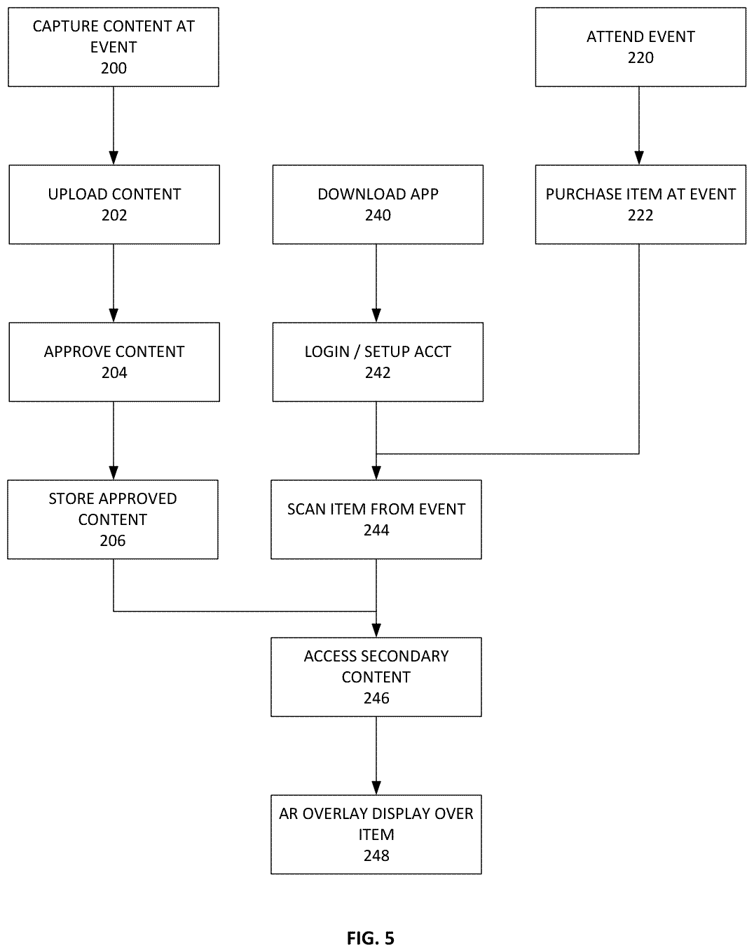

FIG. 5 flowchart of steps of varying embodiments of a method for providing secondary content complimenting a user experience.

The methodology can include 3 convergent sequences of events. A first sequence is capturing or generating content for distribution to users. The generation and management of content can be consistent with the methodology of co-pending patent application Ser. No. 18/095,562 entitled “VISUAL CONTENT MANAGMENET AND DISTRIBUTION SYSTEM AND METHOD” the entirety of which is hereby incorporated by reference.

Step 200 is capturing content at an event. One example may be photographers capturing pictures and video at a concert. One example may be cameras recording a sporting event. This content capture does not necessarily have to specifically be at or from the event, but can be associated with aspects of the event. For example, content can be a recording session for a band or artist, a team's practice session for a sporting event, a personal message from a famous artist or athlete, by way of example.

Step 202 is uploading the content. In one embodiment, the content management system 142 of FIG. 3 receives and manages the uploaded content. This can include tracking information on various legal rights, as well as information about the content itself.

Step 204 can include authorizing content. This authorization can include any variety of steps, including authorization from an author, from the subject of the content, from control organization(s), or any other types of authorization. Authorization can also be directed to specifying the person or persons authorized by view the content, for example restricting content for not viewable by the public at large but rather a designated subset of viewers, e.g. fans with registered accounts.

Step 206 is storing the approved content. This may be stored in the database 144 of FIG. 3.

A secondary sequence of events relate to the fan or user. Step 220 is attending the event itself. For example, if the event is a concert or sporting event, the user may purchase a ticket and physically attend the event. For example, if the event is a virtual event, the user may register and login or otherwise participate via an online application, such as an in-game event for a video game or viewing a launch or release event online.

In one embodiment, step 222 is purchasing an item at the event. In a typical embodiment, the item can be a physical item that includes a logo or other identifying indicia thereon. Examples can include t-shirts, keychains, posters, framed art work, sweatshirts, cups, among other types of merchandise. Here, the user leaves the event with a souvenir, the present method and system transforms that souvenir into a AR content delivery platform.

Further embodiments do not require attendance or purchase for association with an event or content. For example, if a user is a member of a fan club, the fan club can include a poster or other identifier. The user can receive the item, the item itself then usable as the detected first image for secondary content. Another example can be a user purchasing or acquiring physical or online content, such as purchasing a compact disc, vinyl record, purchasing via a music service, etc.

In the third concurrent methodology, step 240 is the user downloading an app on their mobile device. The app can be downloaded from a mobile store or other location. In one embodiment, the user is directed to a download location, such as an app store. The user can be directed via a QR code or other indicia included with the sale of the device, for example a QR code placed on the product hang tag. In another embodiment, accessing the application can be part of the user experience visiting the event, such as a QR code being displayed on a large screen at the event. Any suitable technique can be used to direct the user for acquiring the application.

Once downloaded and locally installed, step 242 is the user either logging in or setting up an account. In one embodiment, the secondary content to be distributed to the user can be controlled by requiring the user to activate the account and provide personal information. This information can be used to track user interactions. This information can be used to verify access to the information such as verifying the user attended the event. This information can also be used to collect personal information, usable for back-end processing including generating loyalty or other content-specific program(s).

The user, once granted access via login, then scans the item using the mobile device. For example, with a mobile phone, the user may hold the phone over a concert t-shirt. In one embodiment, the application uses image recognition processing routines to detect the logo on the t-shirt.

Once the item is recognized, the application can then reference associated secondary connect. In the example of a concert t-shirt, the secondary content can be a practice session clip of the band warming up before the concert or an acoustic version of a popular song, for example.

Step 246 is accessing the secondary content. In one embodiment, the content may be locally stored in a local memory device with permission granted upon both login and recognition of the item. In one embodiment, the content may be stored across a network connection, such generating a network data call to retrieve content.

Step 248 is to generate an AR overlay display over the selected item. Consistent with AR technology, the secondary content is visible within the contours of the item. In the example of the t-shirt, the AR content displays the output over the screen display of the t-shirt. Varying AR embodiments can include zooming and adjustment techniques, including moving the mobile device to adjust the AR output display.

Varying AR embodiments can include additional interactions with the secondary content. These can include navigating between content types using a touchscreen interface, in one embodiment. For example, the content may be a selection of videos and the user is able to manually navigate or scroll between the videos such as using a swiping function on the touchscreen interface. In varying embodiments, the AR content including a selection of AR videos can include all videos downloaded and interacted from a local-storage, a network-based data transmission, or a combination thereof.

Herein, the method and system uses item recognition operations executed in a mobile device as an acquisition trigger to acquire and thus display secondary content. Access to the content is targeted based on association with the item and related events or performers associated with the item. Fans can enjoy extra content to compliment their in-person experience, transforming the souvenir into an interactive platform for additional fan content.

The back-end system can store any number of AR content for distribution to the user. The selected content for distribution can be determined using any number of suitable techniques, including subscription services where new secondary content is made available on a periodic basis in response to a subscription fee. For example, a user may receive none or a limited number of secondary AR content items with an initial purchase or registration, but additional content can be purchased or subscribed. In one example, a fan may subscribe to hear about the band's on-going tour and for a subscription payment can receive weekly messages or other related content.

Another distribution technique can be promotional content periodically transmitted in response to different events or promotional campaigns. Another distribution technique can be user-specific or time-based contents such as general content associated with attending a concert; a thank you message from the artist several days after the concert; and complimentary content at time periods thereafter.

In one embodiment, content distribution can be associated with the user or the user's association. For example if the user is a member of a specific fan club, that user may receive additional secondary content. In another example, the user may receive a timely birthday message or other special message, based on user identification data associated with the mobile viewer application.

Herein, the secondary content can be specific to a particular event, e.g. concert, sporting event, etc., and/or can be specific to particular content, e.g. an album release, a movie release, etc.

The back-end system can additionally coordinate or compliment financial transactions associated with the secondary content. For example, the user attends a concert for her favorite singer, purchases a poster, and then views content from the concert itself to re-enjoy the event. While enjoying the event, a still image from the secondary content can be made available for printing on a poster, t-shirt, sweatshirt, or other item, Therefore, the back-end system can enable communication with the commercial transaction platform with the selected image, in one embodiment using the user data to help consummate the transaction.

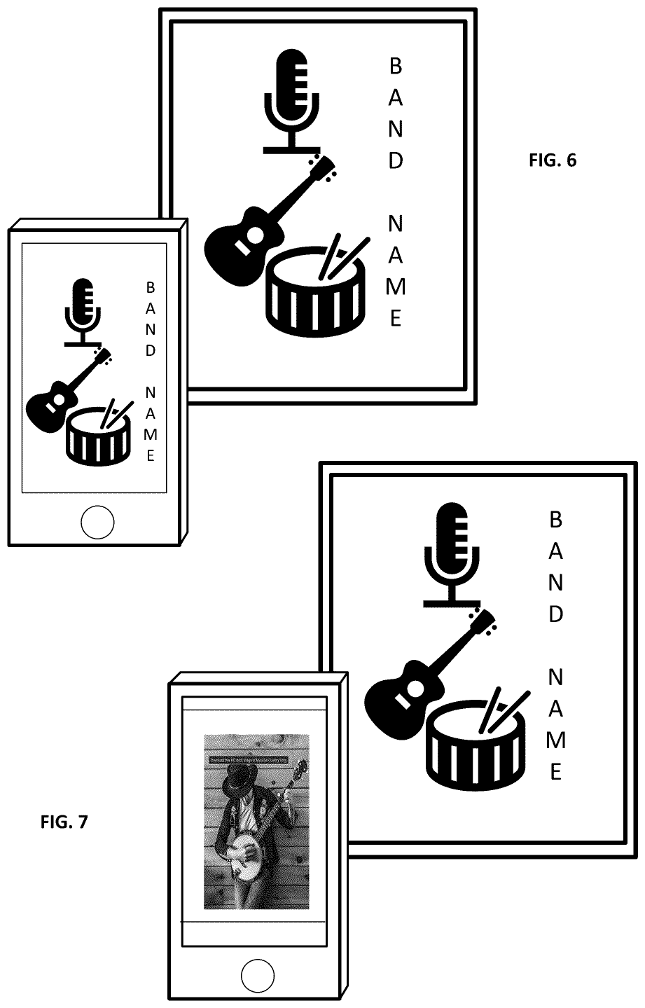

By way of example, FIG. 6 illustrates an example of the item being a framed picture of a band logo. The mobile device executes the application and uses the camera to capture the display of the framed picture. In FIG. 7, the mobile device then generates a secondary display of a video of the band leader performing an acoustic version of a song. This mobile device display is in the AR overlay.

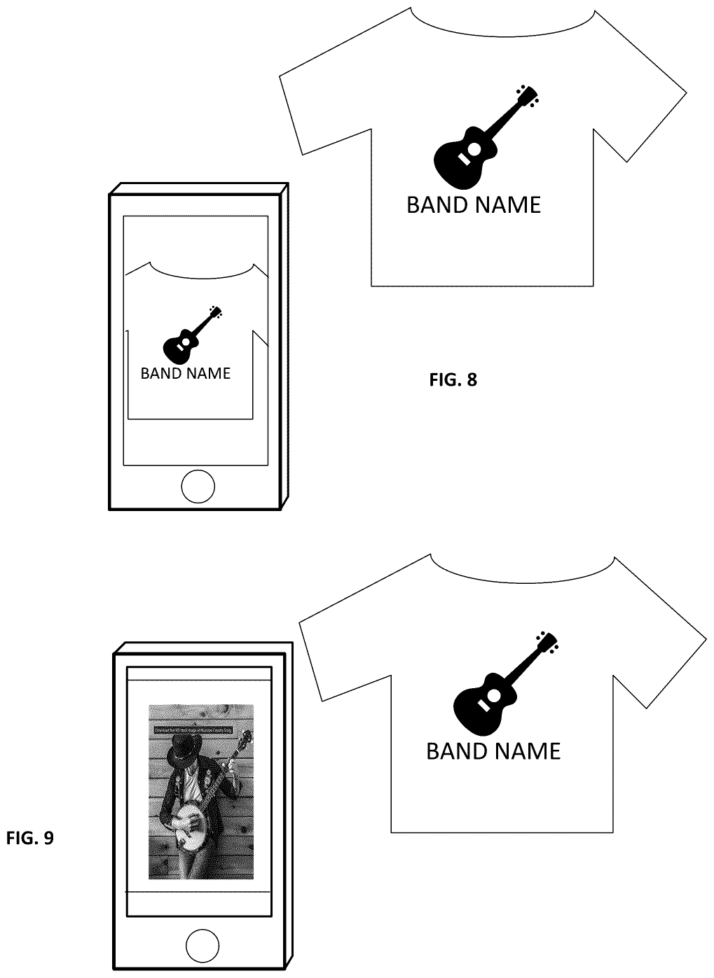

By way of example, FIG. 8 illustrates the item being a t-shirt with the band name. The mobile application recognizes the shirt and FIG. 9 is another example of AR secondary content.

While the invention has been described with respect to certain embodiments, the description is intended to be exemplary, rather than limiting. Modifications and changes may be made within the scope of the invention.

FIGS. 1-9 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. As used herein, executable operations and executable instructions can be performed based on transmission to one or more processing devices via storage in a non-transitory computer readable medium.

What is claimed is:

1. An augmented reality content distribution method for distributing secondary content, the method comprising:
via an image capture application executing on a mobile computing device, detecting a first image disposed on a physical item, the physical item relating to a primary event and/or primary content;
accessing a secondary content database across a network communication path;
retrieving the secondary content based on the first image as detected by the image capture application; and
displaying, on an output display of the mobile computing device, the secondary content in an augmented reality display in relation to the first image and the physical item, wherein the secondary content is associated with the primary event and/or primary content.

2. The augmented reality content distribution method of claim 1, wherein the physical item is a merchandise item associated with the primary event being an entertainment event.

3. The augmented reality content distribution method of claim 2, wherein the merchandise item is one of: a t-shirt, a sweatshirt, a sweater, a hat, a bandana, a scarf, a cup, a mug, a poster, a keychain, a wallet, a mobile phone case, or an album cover.

4. The augmented reality content distribution method of claim 1, wherein the first image disposed on the physical item is an image relating to the primary event and/or primary content.

5. The augmented reality content distribution method of claim 1, wherein the first image disposed on the physical item is an image of one or more persons or items associated with the primary event and/or primary content.

6. The augmented reality content distribution method of claim 1 further comprising:
updating the secondary content database with new secondary content.

7. The augmented reality content distribution method of claim 6 further comprising:
receiving a notification in the mobile computing device, the notification including a notifier that the secondary content database includes the new secondary content.

8. The augmented reality content distribution method of claim 7 further comprising:
after receipt of the notification, via the image capture application, detecting the first image disposed on the physical item;
accessing the secondary content database;
retrieving the new secondary content; and
displaying, on the output display, the new secondary content in the augmented reality display in relation to the first image and the physical item.

9. The augmented reality content distribution method of claim 6 further comprising:
receiving a subscription request from a user operating the mobile computing device, the subscription relating to receipt of the new secondary content; and
receiving the new secondary content in the mobile computing device in based on the subscription request.

10. An augmented reality content distribution system for distributing secondary content, the system comprising:
a secondary content database have the secondary content stored therein, the secondary content include augmented reality content;
a network-based server for communicating with the secondary content database via a network communication path; and
an application including executable instructions storable in a non-transitory computer readable medium on a mobile computing device such that mobile computing device, via a processing device disposed therein, is operative to:
via an image capture operation, detecting a first image disposed on a physical item, the physical item relating to a primary event and/or primary content;
accessing the secondary content database via the network-based server across the network communication path;
retrieving the secondary content based on the first image as detected by the image capture application;
receiving the secondary content in the mobile computing device; and
displaying, on an output display of the mobile computing device, the secondary content in an augmented reality display in relation to the first image and the physical item, wherein the secondary content is associated with the primary event and/or primary content.

11. The augmented reality content distribution system of claim 10, wherein the physical item is a merchandise item associated with the primary event being an entertainment event.

12. The augmented reality content distribution system of claim 11, wherein the merchandise item is one of: a t-shirt, a sweatshirt, a sweater, a hat, a bandana, a scarf, a cup, a mug, a poster, a keychain, a wallet, a mobile phone case, or an album cover.

13. The augmented reality content distribution system of claim 10, wherein the first image disposed on the physical item is an image relating to the primary event and/or primary content.

14. The augmented reality content distribution system of claim 10, wherein the first image disposed on the physical item is an image of one or more persons or items associated with the primary event and/or primary content.

15. The augmented reality content distribution system of claim 10, wherein the secondary content database receives new secondary content, the mobile computing device is operative to receive a notification from the network-based server, the notification including a notifier that the secondary content database includes the new secondary content.

16. The augmented reality content distribution system of claim 15, the processing device is further operative to:
after receipt of the notification, via the image capture application, detect the first image disposed on the physical item;
access the secondary content database;
retrieve the new secondary content; and
display, on the output display, the new secondary content in the augmented reality display in relation to the first image and the physical item.

17. The augmented reality content distribution method of system of claim 7, the processing device is further operative to:
receive a subscription request from a user operating the mobile computing device, the subscription relating to receipt of the new secondary content; and
receive the new secondary content in the mobile computing device in based on the subscription request.

18. An augmented reality content distribution method for distributing secondary content, the method comprising:
via an image capture application executing on a mobile computing device, detecting a first image disposed on a physical item, the physical item is a merchandise item associated with a primary event being an entertainment event;
accessing a secondary content database across a network communication path;
retrieving the secondary content based on the first image as detected by the image capture application;
displaying, on an output display of the mobile computing device, the secondary content in an augmented reality display in relation to the first image and the physical item, wherein the secondary content is associated with the primary event and/or primary content;
determining if the user includes a subscription to secondary content; and
if a subscription is confirmed, receiving the new secondary content in the mobile computing device in based on the subscription request.

19. The augmented reality content distribution method of claim 18 further comprising:
updating the secondary content database with the new secondary content.

20. The augmented reality content distribution method of claim 19 further comprising:
receiving a notification in the mobile computing device, the notification including a notifier that the secondary content database includes the new secondary content.
